(19) United States
(12) Patent Application Publication
(10) Pub. No.: US 2009/0090332 A1
(43) Pub. Date: Apr. 9, 2009

(54) Method and System to Mitigate Deposit Formation on a Direct Injector for a Gasoline-Fuelled Internal Combustion Engine

(76) Inventor: Diana D. Brehob, Dearborn, MI (US)

Correspondence Address: FORD GLOBAL TECHNOLOGIES, LLC, FAIRLANE PLAZA SOUTH, SUITE 800, 330 TOWN CENTER DRIVE, DEARBORN, MI, 48126, US

(21) Appl. No.: 11/866,446

(22) Filed: Oct. 3, 2007

(51) Int. Cl. F02M 63/02

(52) U.S. Cl. 123/464; 123/446; 123/480; 701/104

(57) ABSTRACT

In an internal combustion engine having both a port injector and a direct injector supplying fuel to a cylinder of the engine, a method is disclosed for avoiding deposit formation on and/or inside the tip of the direct injector. The tip temperature is estimated. When the tip temperature exceeds a threshold temperature at which deposits are formed, the amount of fuel delivered by the direct injector is increase.

### FIELD OF THE INVENTION

Deposits can form on and in injectors which are disposed within a combustion chamber of a gasoline-fuelled engine. The present invention concerns mitigating such deposit formation.

### BACKGROUND OF THE INVENTION

Direct injection (DI) for gasoline-fuelled engines present a fuel economy benefit by providing charge cooling, thereby allowing a modest increase in compression ratio. A drawback of direct injection, however, is that there is less time available for the fuel injection to take place compared to port injection. That is, with a port injected engine, the fuel injection pulse width can comprise almost 720 crank degrees. The fuel sprayed in the port during a period when the intake valve is closed is inducted during the next induction stroke. However, DI is not so flexible. For example, fuel which is to participate in the combustion event cannot be injected during a period in which exhaust gases are flowing out of the cylinder. Furthermore, there are mixing limitations placed upon fuel injection during the intake and compression strokes in that the injection timing affects the homogeneity achieved at the time of spark firing. Due to the limitations on DI timing, obtaining the appropriate amount of fuel for the lowest fuel delivery and highest fuel delivery requirements is a challenge with DI. That is, due to DI's limitations in injection pulse width to meet the highest injection demands causes the pulse widths at the lowest injection demands to be in a nonlinear range of the injector, meaning a high degree of variability in the pulse-to-pulse fuel delivery quantity.

To overcome such problems, it is known to provide both port and direct injectors. This can be accomplished by providing a central injector (or multiple injectors) upstream of the intake manifold branches leading to the cylinders or by providing a port injector in the intake port for each cylinder. At the lowest fuel demands, the port injector can be used alone. At higher fuel demands, the direct injector can be used alone. This provides for less compromise in the design of the direct injector in that it no longer is called upon to provide a repeatable quantity of fuel from injection to injection at the lowest fuel demands.

During periods in which the direct injector has no fuel flow through it, the injector is no longer provided cooling by the fuel flow. The fuel trapped at the injector tip can get very hot and undergo chemical reactions which cause deposit buildup. These deposits can occur within the injector tip thereby effectively reducing the cross-sectional area of the injector orifice or orifices, depending on whether the injector has a single hole or multiple holes. Additionally, deposits can from on the tip's external surface also having the effect of reducing the effective cross-sectional area of the injector orifices and/or interfering with the injector spray pattern.

The inventors of U.S. Pat. No. 6,988,490 have recognized such a problem and propose increasing the tip temperature of the direct injector to enable periodic burning of the accumulated deposits. The inventor of the present invention has recognized several problems with this solution. First, such a proposal can only remove accumulated deposits that form on the outside surfaces of the injector, i.e., deposits that are in communication with oxygen so that they can be burned. Deposit formation within the orifices of the injector, forming in areas within the injector having limited access to oxygen would be exacerbated by the even higher temperatures experienced during the cleaning operation. Secondly, depending on the operating condition of the engine when such a requirement for increasing injector tip temperature is demanded can lead to a reduction in fuel economy.

### SUMMARY OF THE INVENTION

The inventor of the present invention recognizes that it is advantageous to prevent the formation of deposits as opposed to burning off the deposits once formed. To mitigate the formation of deposits, the temperature of the injector tip is maintained below a threshold temperature so that the fuel at the tip is sufficiently cool so that the reactions which lead to deposit formation do not occur.

A method to operate an internal combustion engine having both a port injector and a direct injector supplying fuel to a cylinder of the engine is disclosed in which an estimate of the tip temperature of the direct injector is determined. If the tip temperature exceeds a threshold temperature, the fuel delivered by the direct injector is increased and the fuel delivered by the port injector is decreased. By providing more fuel through the direct injector, the direct injector is cooled by the fuel flowing through it.

In one embodiment, the tip temperature is estimated based on temperature measured in the vicinity of the injector tip. Alternatively, the tip temperature is modeled based on one or more of: engine coolant temperature, engine speed, engine torque, vehicle speed, time since the direct injector was last commanded a pulse width, and ambient temperature.

Also disclosed is a method to operate an internal combustion engine having both a port injector and a direct injector supplying fuel to a cylinder of the engine in which the engine is operated according to a normal operating mode when a tip temperature of the direct injector is below a threshold temperature and the normal engine operating mode is interrupted when a tip temperature of the direct injector is above the threshold temperature. The interruption of the normal engine operation involves increasing fuel delivered by the direct injector and decreasing fuel delivered by the port injector.

### BRIEF DESCRIPTION OF THE DRAWINGS

The advantages described herein will be more fully understood by reading an example of an embodiment in which the invention is used to advantage, referred to herein as the Detailed Description, with reference to the drawings, wherein:

FIG. 1 is a schematic of an engine having two PI and DI injectors;

FIG. 2 is an engine operating map of torque and engine rpm showing an example of a normal engine operating mode; and

FIG. 3 is a flowchart indicating an embodiment of the present invention in which the direct injector tip temperature is maintained below a threshold temperature.

### DETAILED DESCRIPTION

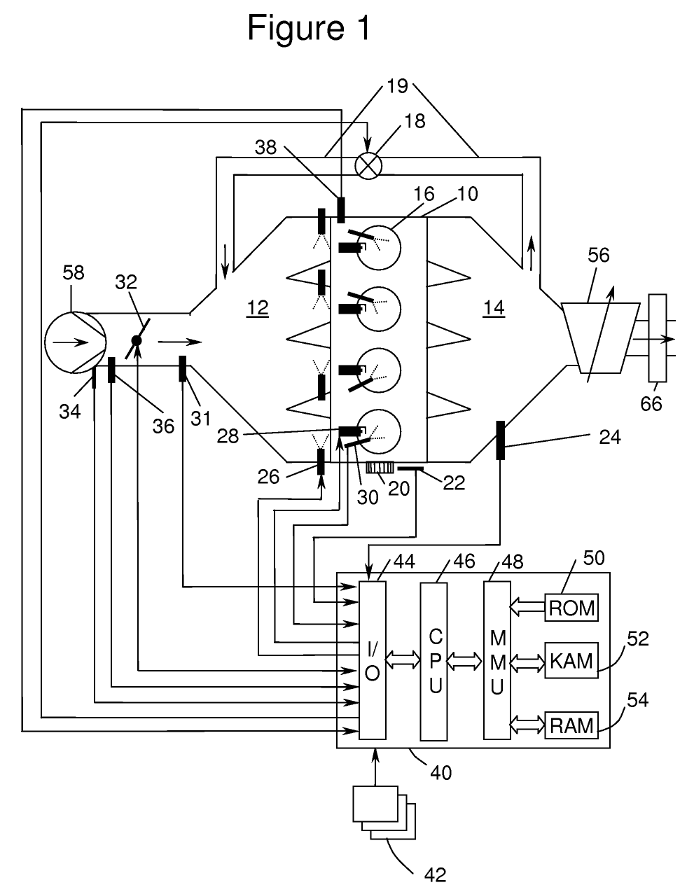

A 4-cylinder internal combustion engine 10 is shown, by way of example, in FIG. 1. Engine 10 is supplied air through intake manifold 12 and discharges spent gases through exhaust manifold 14. An intake duct upstream of the intake manifold 12 contains a throttle valve 32 which, when actuated, controls the amount of airflow to engine 10. Sensors 34 and 36 installed in intake manifold 12 measure air temperature and mass air flow (MAF), respectively. Sensor 31, located in intake manifold 14 downstream of throttle valve 32, is a manifold absolute pressure (MAP) sensor. A partially closed throttle valve 32 causes a pressure depression in intake manifold 12 compared to the pressure on the upstream side of throttle valve 32. When a pressure depression exists in intake manifold 12, exhaust gases are caused to flow through exhaust gas recirculation (EGR) duct 19, which connects exhaust manifold 14 to intake manifold 12. Within EGR duct 19 is EGR valve 18, which is actuated to control EGR flow. Fuel is supplied to engine 10 by fuel injectors 30, injecting directly into cylinders 16, and port injectors 26 supply fuel into intake manifold 12. Each cylinder 16 of engine 10 contains a spark plug 28. The crankshaft (not shown) of engine 10 is coupled to a toothed wheel 20. Sensor 22, placed proximately to toothed wheel 20, detects engine 10 rotation. Other methods for detecting crankshaft position may alternatively be employed.

In one embodiment, the engine is pressure charged by a compressor 58 in the engine intake. By increasing the density of air supplied to engine 10, more fuel can be supplied at the same equivalence ratio. By doing so, engine 10 develops more power. Compressor 58 can be a supercharger which is typically driven off the engine. Alternatively, compressor 58 is connected via a shaft with a turbine 56 disposed in the engine exhaust. Turbine 56, as shown in FIG. 1, is a variable geometry turbine; but, may be, in an alternative embodiment, a non-variable device. In another embodiment, the engine is naturally aspirated, in which embodiment elements 56 and 58 are omitted. Downstream of turbine 56 is three-way catalyst 66. Three-way catalyst 66 can alternatively be placed upstream of turbine 56 for faster light-off. Alternatively, catalyst 66 is a lean NOx trap or lean NOx catalyst having the capability to reduce NOx at a lean equivalence ratio.

Continuing to refer to FIG. 1, electronic control unit (ECU) 40 is provided to control engine 10. ECU 40 has a microprocessor 46, called a central processing unit (CPU), in communication with memory management unit (MMU) 48. MMU 48 controls the movement of data among the various computer readable storage media and communicates data to and from CPU 46. The computer readable storage media preferably include volatile and nonvolatile storage in read-only memory (ROM) 50, random-access memory (RAM) 54, and keep-alive memory (KAM) 52, for example. KAM 52 may be used to store various operating variables while CPU 46 is powered down. The computer-readable storage media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by CPU 46 in controlling the engine or vehicle into which the engine is mounted. The computer-readable storage media may also include floppy disks, CD-ROMs, hard disks, and the like. CPU 46 communicates with various sensors and actuators via an input/output (I/O) interface 44. Examples of items that are actuated under control by CPU 46, through I/O interface 44, are fuel injection timing, fuel injection rate, fuel injection duration, throttle valve 32 position, spark plug 28 timing, EGR valve 18. Various other sensors 42 (such as a humidity sensor, an engine block accelerometer, an in-line torque sensor, cylinder pressure transducer sensor, an ionization sensor, as examples) and specific sensors (engine speed sensor 22, engine coolant sensor 38, manifold absolute pressure sensor 31, exhaust gas component sensor 24, air temperature sensor 34, and mass airflow sensor 36) communicate input through I/O interface 44 and may indicate engine rotational speed, vehicle speed, coolant temperature, manifold pressure, pedal position, cylinder pressure, throttle valve position, air temperature, exhaust temperature, exhaust stoichiometry, exhaust component concentration, and air flow. Some ECU 40 architectures do not contain MMU 48. If no MMU 48 is employed, CPU 46 manages data and connects directly to ROM 50, RAM 54, and KAM 52. Of course, the present invention could utilize more than one CPU 46 to provide engine control and ECU 60 may contain multiple ROM 50, RAM 54, and KAM 52 coupled to MMU 48 or CPU 46 depending upon the particular application.

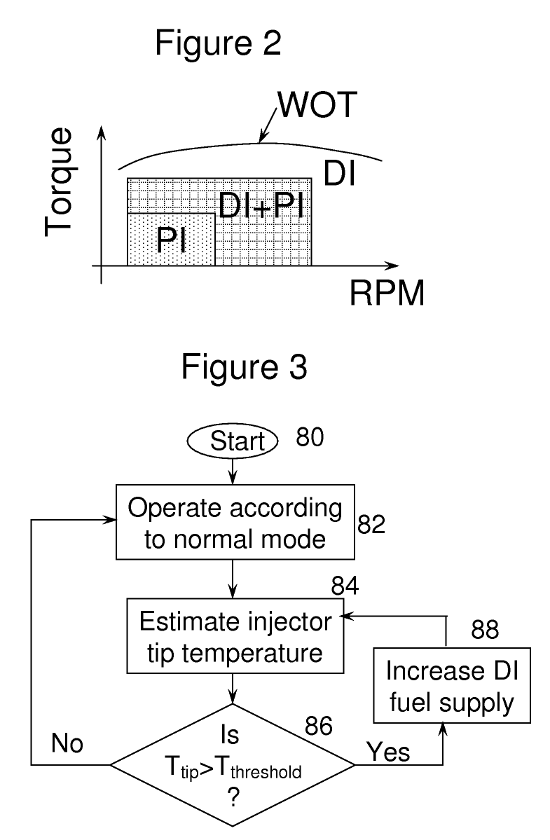

In FIG. 2, one embodiment of an operating map is shown in which the upper curve, labeled WOT for wide open throttle, shows the maximum torque that the engine can develop over the speed range. At the lowest speed and torque conditions, PI only is used. At moderate speeds and torques, DI and PI are used. At the highest speeds and/or torques, DI is used. FIG. 2 is shown by way of example and is in no way intended to be limiting. It is simply one example of a normal engine operating mode. A wide variety of strategies could be employed as the normal engine operating mode, which strategies are not the subject matter of the present invention.

In FIG. 3, engine operation starts in step 80 according to a normal engine operating mode in step 82. Control passes to step 84 in which the injector tip temperature is estimated based on measured temperatures and/or modeled based on operating conditions. In step 86, it is determined whether the tip temperature exceeds the threshold temperature, i.e., that temperature at which deposit formation occurs. If the temperature exceeds the threshold, DI fuel supply is increased. If not, control passes back to step 82 to operate at the normal engine operating mode. Both operating modes: normal mode and the injector cooling mode in which fuel is preferentially supplied by the DI injector return to step 84 to continue to monitor the injector tip operating temperature.

While several modes for carrying out the invention have been described in detail, those familiar with the art to which this invention relates will recognize alternative designs and embodiments for practicing the invention. The above-describe embodiments are intended to be illustrative of the invention, which may be modified within the scope of the following claims.

I claim:

1. A method to operate an internal combustion engine having both a port injector and a direct injector supplying fuel to a cylinder of the engine, the method comprising:
determining an estimate of the tip temperature of the direct injector; and
increasing fuel delivered by the direct injector when said estimated tip temperature exceeds a threshold temperature.

2. The method of claim 1 wherein said direct injector is supplying substantially no fuel prior to said determining of tip temperature.

3. The method of claim 1 wherein said threshold temperature is an injector tip temperature at which fuel coking occurs.

4. The method of claim 1 wherein prior to said determining of tip temperature, fuel is supplied to the engine by the port injector, the method further comprising:
commanding zero pulse width to the port injector when said estimated tip temperature exceeds said threshold temperature.

5. The method of claim 1 wherein said determining of tip temperature is based on a measurement of injector temperature.

6. The method of claim 1 wherein said determining of tip temperature is based on a model using at least one of engine coolant temperature, engine speed, and engine torque as inputs to said model.

7. The method of claim 1 wherein said determining of tip temperature is based on a modal using at least one of vehicle speed, time since the direct injector was last commanded a pulse width, and ambient temperature as inputs to said model.

8. The method of claim 1 wherein said increasing fuel delivered by the direct injector takes into account fuel inventory on engine port walls so that a desired air-fuel ratio is provided to the engine's combustion chamber.

9. A method to operate an internal combustion engine having both a port injector and a direct injector supplying fuel to a cylinder of the engine, the method comprising:
operating in a normal engine operating mode when a tip temperature of the direct injector is below a threshold temperature;
interrupting said normal engine operating mode when a tip temperature of the direct injector is above said threshold temperature.

10. The method of claim 9 wherein said interrupting comprises increasing fuel delivered by the direct injector and decreasing fuel delivered by the port injector.

11. The method of claim 9 wherein an amount of fuel supplied to the engine's combustion chamber is substantially constant just prior to and just after said interrupting.

12. The method of claim 10 wherein a pulse width increase commanded to the direct injector and a pulse width decrease commanded to the port injector are coordinated so that a desired air-fuel ratio is provided to the engine's combustion chamber.

13. The method of claim 12 wherein said desired air-fuel ratio is a stoichiometric air-fuel ratio.

14. A fuel injection system for an internal combustion engine, comprising:
A port injector adapted to supply fuel to an engine at a location upstream of an engine combustion chamber;
a direct injector adapted to supply fuel to said engine combustion chamber; and
an electronic control until electronically coupled to the engine, the port injector, and the direct injector, said electronic control unit determining a temperature of a tip of the direct injector, said electronic control unit further commanding an increased pulse width to said direct injector when said tip temperature exceeds a threshold temperature.

15. The system of claim 14 wherein said tip temperature is a temperature at which fuel deposits form.

16. The system of claim 14 wherein said electronic control unit commanding a decreased pulse width to said port injector simultaneous to said command of said increased pulse width to said direct injector.

17. The system of claim 14 wherein said tip temperature is determined based on sensor inputs to said electronic control unit.

18. The system of claim 14 wherein said tip temperature determination is based on engine operating condition.

19. The system of claim 16 wherein said increasing pulse width and said decreasing pulse width are determined so as to provide a desired air-fuel ratio to said engine combustion chamber.

20. The system of claim 19 wherein said increasing pulse width and said decreasing pulse width are determined partially based an inventory of fuel located within a port area upstream of said engine combustion chamber.
